(19) United States
(12) Patent Application Publication
(10) Pub. No.: US 2005/0121813 A1
(43) Pub. Date: Jun. 9, 2005

(54) Method of forming photovoltaic device lens and method of fabricating photovoltaic panel

(75) Inventors: Koichi Asai, Nagoya-shi (JP); Kazutoshi Sakai, Nagoya-shi (JP); Kazuya Suzuki, Toyota-shi (JP); Shunji Yoshikane, Nishikamo-gun (JP); Hironobu Ichikawa, Nagoya-shi (JP)

Correspondence Address: FOLEY AND LARDNER;SUITE 500, 3000 K STREET NW, WASHINGTON, DC, 20007, US

(73) Assignee: FUJI MACHINE MFG. CO., LTD

(21) Appl. No.: 10/954,338

(22) Filed: Oct. 1, 2004

(30) Foreign Application Priority Data
Oct. 3, 2003 (JP) 2003-345292

(51) Int. Cl. B29D 11/00; B32B 31/00

(52) U.S. Cl. 264/1.32; 156/84

(57) ABSTRACT

An object of the present invention is to form suitable spherical convex lens on the surfaces of spherical or granular photovoltaic devices in an easy and cost-effective method even when the photovoltaic devices have variations in the size and shape. To achieve the object, the invention is a method in which are carried out immersing the photovoltaic device in a liquid resin and lifting the photovoltaic device, thereby causing the liquid resin to adhere to the surface of the photovoltaic device, and hardening the liquid resin adherent to the surface of the photovoltaic device, thereby forming a resin lens on the surface of the photovoltaic device. Since a spherical convex lens is formed on the surface of the photovoltaic device by surface tension of the resin liquid, a suitable spherical convex lens can be formed on the surface of the photovoltaic device and the photovoltaic device can be positioned at the center of the lens even when the photovoltaic devices have variations in the size and shape.

### BACKGROUND OF THE INVENTION

1. Field of the Invention

This invention relates to a method of forming a lens on a surface of a spherical or granular photovoltaic device and a method of fabricating a photovoltaic panel having a number of spherical or granular photovoltaic devices arranged in an array.

2. Description of the Related Art

JP-A-2001-168369 and JP-A-2002-280592 disclose spherical or granular photovoltaic devices in order to improve a generating efficiency of a photovoltaic panel which converts solar energy into electric energy, for example. The spherical or granular photovoltaic device provides a substantially constant project area (an amount of received light) when viewed from every direction of incidence of sunlight. Accordingly, even when the sun altitude is low, power generation can advantageously be performed as efficiently as when the sun altitude is high.

JP-A-2001-168369 describes the photovoltaic panel including a light-transmissible resin casing and a number of spherical or granular photovoltaic devices arranged in an array and housed in the casing (a method of manufacturing the structure is not disclosed). A reflector is bonded to a backside of the casing so that light reflected on the reflector is received by the photovoltaic devices for the purpose of improving the power generating efficiency.

On the other hand, JP-A-2002-280592 describes the photovoltaic panel including a device-holding plate having one side (light receiving side) formed with a number of recesses and spherical or granular photovoltaic devices accommodated and bonded in the recesses respectively. Electrodes of the respective photovoltaic devices are formed on the other side of the device-holding plate, whereupon light incident on the photovoltaic devices is prevented from being blocked by the electrodes.

Regarding a method of manufacturing spherical or granular photovoltaic devices, international publication No. WO99/10935 discloses a free fall method in which drops of silicon heated to be liquefied are caused to fall free so as to be deformed by surface tension into a spherical or granular shape and solidified. JP-A-2002-60943 discloses a plasma-assisted CVD method in which Si is deposited on the entire surface of a core member in a plasma-assisted CVD machine to be formed into spherical or granular photovoltaic devices.

In order that a generating efficiency of a photovoltaic panel may be improved, it is effective to form a lens on a surface of the photovoltaic device so that sunlight incident around the photovoltaic device is also condensed by the lens thereby to be received by the photovoltaic devices.

When to be formed in the aforementioned conventional photovoltaic panels, it is considered that a lens is made from a light-transmissible resin by the injection molding. However, the spherical or granular photovoltaic devices formed by the free fall method or plasma-assisted CVD method are small in size and moreover have variations in the size (diameter) or shape (sphericity). As a result, it is difficult to make spherical convex lens suitable for the respective photovoltaic devices.

### SUMMARY OF THE INVENTION

Therefore, an object of the present invention is to forming suitable spherical convex lens on the surfaces of spherical or granular photovoltaic devices in an easy and cost-effective method even when the photovoltaic devices have variations in the size (diameter) and shape (sphericity) and further, manufacturing, in an easy and cost-effective method, a photovoltaic panel provided with lens and having a high generating efficiency.

To achieve the object, the present invention is a method in which are carried out immersing the photovoltaic device in a liquid resin and lifting the photovoltaic device, thereby applying the liquid resin to the surface of the photovoltaic device, and hardening the liquid resin adherent to the surface of the photovoltaic device, thereby forming a resin lens on the surface of the photovoltaic device. Since a spherical convex lens is formed on the surface of the photovoltaic device by surface tension of the resin liquid, a suitable spherical convex lens can be formed on the surface of the photovoltaic device and the photovoltaic device can be positioned at the center of the lens even when the photovoltaic devices have variations in the size (diameter) and shape(sphericity). Moreover, no expensive forming machine, such as forming dies for injection molding, forming the lens is required, and the spherical convex lens can be formed on the surface of the photovoltaic device in an easy and cost-effective manner in which the photovoltaic device is immersed in the resin liquid, lifted and the resin liquid is hardened. Thus, optimization of the shape of lens and low costs can be achieved simultaneously.

In this case, the liquid resin applying process and the liquid resin hardening process are repeated alternately at a predetermined number of times so that the lens formed on the surface of the photovoltaic device has an increased thickness. Consequently, the thickness of the lens can be adjusted by adjustment of the number of times of immersing the photovoltaic device in the liquid resin and hardening the liquid resin and accordingly, even a thick lens can be made.

In this case, a light-transmissible thermosetting resin or the like may be used as the resin for forming the lens. However, it is more preferable to use a light-transmissible ultraviolet curing resin or the like. As a result, the resin can be hardened by ultraviolet radiation in a short period of time (several to several tens seconds) and accordingly, the yield can be improved.

Further, a method of manufacturing a photovoltaic panel having an array of a number of spherical or granular photovoltaic devices, comprises preliminarily holding the photovoltaic devices on one side of a preliminarily holding sheet with a space between each device and an adjacent one, immersing the photovoltaic devices held on the side of the preliminarily holding sheet in a liquid resin and lifting the photovoltaic devices, thereby applying the liquid resin to the surfaces of the photovoltaic devices, hardening the liquid resin applied to the surfaces of the photovoltaic devices, thereby forming resin lens on the surfaces of the photovoltaic devices respectively, applying a bonding agent to surfaces of the lens, and shrinking the preliminarily holding sheet in a direction of extension of the sheet so that the lens of each photovoltaic device is bonded to the lens of the adjacent one, thereby forming the photovoltaic panel.

Consequently, more preferable spherical convex lens can be manufactured collectively on the surfaces of a number of photovoltaic devices by the surface tension even when the photovoltaic devices held on the preliminarily holding sheet varies in the size and shape. Moreover, the preliminarily holding sheet is shrunk in the direction of extension of the sheet after formation of the lens, so that the lens of each photovoltaic device is bonded to the lens of the adjacent one. Consequently, the photovoltaic devices can be integrated by an easy and cost-effective method without using expensive forming equipment. Thus, a photovoltaic panel provided with lens and having a high generating efficiency can be manufactured.

In this case, too, the liquid resin applying process and the liquid resin hardening process are repeated alternately at a predetermined number of times so that the lens formed on the surface of the photovoltaic device has an increased thickness. Consequently, the thickness of the lens can be adjusted by adjustment of the number of times of immersing the photovoltaic device in the resin liquid and hardening the resin liquid and accordingly, even a thick lens can be made.

Further, after the preliminarily holding sheet has been removed from the photovoltaic panel, an electrode of each photovoltaic device may be formed on a side of the photovoltaic panel from which the preliminarily holding sheet has been removed. Consequently, since the electrodes are formed on the backside of the photovoltaic panel, light incident on the photovoltaic devices can be prevented from being intercepted by the electrodes and accordingly, the entire surface of each lens can effectively serve as a light-receiving face.

In this case, the electrode may be formed so as to cover a backside of each lens. Since the electrode serves as a reflecting surface of the incident light, the generating efficiency (an amount of light received by the photovoltaic device) can further be improved by the light reflecting action of the electrode.

On the other hand, in the preliminarily holding process, a number of photovoltaic devices may be caused to adhere to one side of the preliminarily holding sheet while a uniform space is defined between each photovoltaic device and the adjacent one. In this manner, however, the photovoltaic devices need to be aligned by some method with the uniform space between each photovoltaic device and the adjacent one before applied to one side of the preliminarily holding sheet. This can become a troublesome work.

In view of the aforesaid problem, a sheet made from an elastic material expandable and contractible in the direction of extension of the sheet serves as the preliminarily holding sheet. The photovoltaic devices are caused to adhere to one side of the preliminarily holding sheet in a closely massed state and thereafter, the preliminarily holding sheet is drawn out uniformly in the direction of extension of the sheet so that a uniform space is defined between each photovoltaic device and the adjacent one. Consequently, the photovoltaic devices need not be aligned with the uniform space between each photovoltaic device and the adjacent one before caused to adhere to one side of the preliminarily holding sheet. Accordingly, causing the photovoltaic devices to adhere to one side of the preliminarily holding sheet can be carried out easily. Moreover, a uniform space can be defined between the photovoltaic devices by an easy method of uniformly drawing the sheet in the direction of extension of the sheet.

When the resin liquid is adhered to the preliminarily holding sheet, the adherent liquid resin may serve as a bonding agent to bond the preliminarily holding sheet and photovoltaic panel. As a result, it becomes difficult to remove the preliminarily holding sheet, and the adherent liquid resin becomes an obstacle preventing the sheet from shrinking, whereupon there is a possibility that each lens cannot be bonded to the adjacent one.

As one countermeasure, only the photovoltaic devices are immersed in the liquid resin so that the liquid resin is prevented from adhering to the preliminarily holding sheet in the immersing process. Consequently, the aforesaid drawback due to adherence of the resin liquid to the preliminarily holding sheet can be prevented.

In this case, it is preferable that the bonding agent comprises a resin which is the same as forming each lens but has a lower viscosity than the resin forming each lens. Consequently, the optical characteristic of the bonding agent after hardening can correspond to that of the lens while a preferable viscosity is maintained, and the bonding agent can completely integrated as a part of the lens, whereupon an optical characteristic of the lens can be prevented from being degraded by the bonding agent.

Further, in the bonding agent applying process, the lens of the photovoltaic devices preliminarily held on the preliminarily holding sheet may be immersed in a liquid of said bonding agent so that the bonding agent adheres to the surface of the lens of each photovoltaic device. Consequently, the bonding agent can be applied collectively to the surfaces of the lens of a number of photovoltaic devices and accordingly, the bonding agent applying work can be carried out easily in the same manner as the lens forming (immersing method). Moreover, since the bonding agent can uniformly be applied to the lens surfaces of a number of photovoltaic devices by the immersing method, the optical characteristic of the lens can be prevented from being reduced by the bonding agent. In this bonding agent applying process, it is preferable that only the lens of each photovoltaic device is immersed in the liquid of bonding agent so that the bonding agent is prevented from adhering to the preliminarily holding sheet.

### BRIEF DESCRIPTION OF THE DRAWINGS

Other objects, features and advantages of the present invention will become clear upon reviewing of the following description of the embodiments, made with reference to the accompanying drawings, in which:

FIG. 1A illustrates a process in which a number of photovoltaic devices are accommodated in a casing with a shallow bottom in a crowded state with respect to a manufacturing process for the photovoltaic panel in accordance with one embodiment of the present invention;

FIG. 1B illustrates a process of adhering the photovoltaic devices to the underside of the preliminarily holding sheet in the crowded state;

FIG. 1C illustrates a process of drawing the preliminarily holding sheet uniformly in the direction of extension of the sheet so that a space is increased uniformly between each photovoltaic device and the adjacent one;

FIG. 1D illustrates a process of immersing the photovoltaic devices on the underside of the preliminarily holding sheet in resin liquid;

FIG. 1E illustrates a process of irradiating ultraviolet light onto resin liquid adherent to the surface of each photovoltaic device on the underside of the preliminarily holding sheet to harden the resin liquid, thereby forming a lens;

FIG. 1F illustrates a process of simultaneously immersing the lens of the photovoltaic devices on the underside of the preliminarily holding sheet;

FIG. 1G illustrates the bonding agent adherent to the lens of the photovoltaic devices on the underside of the preliminarily holding sheet;

FIG. 1H illustrates the preliminarily holding sheet shrunk in the direction of extension of the sheet so that the bonding agent adherent to each lens is brought into contact with each other;

FIG. 1I illustrates a process of irradiating ultraviolet light onto the bonding agent between the lens of the photovoltaic devices so that the lens are bonded together;

FIG. 1J illustrates a process of removing the preliminarily holding sheet from the backside of the photovoltaic panel;

FIG. 1K illustrates a process of forming negative electrodes on the backside of the photovoltaic panel;

FIG. 1L illustrates a process of forming a protecting layer (lower insulating resin layer) covering over the negative electrodes on the backside of the photovoltaic panel;

FIG. 1M illustrates a sand blast process for exposing an n-type semiconductor layer of the rear end of the photovoltaic device;

FIG. 1N illustrates a process of forming an insulating layer (upper insulating resin layer) over the entire backside of the photovoltaic panel;

FIG. 10 illustrates a process of abrading the insulating layer of the backside of the photovoltaic panel so that a p-type semiconductor layer of the rear end of the photovoltaic device is exposed from the insulating layer;

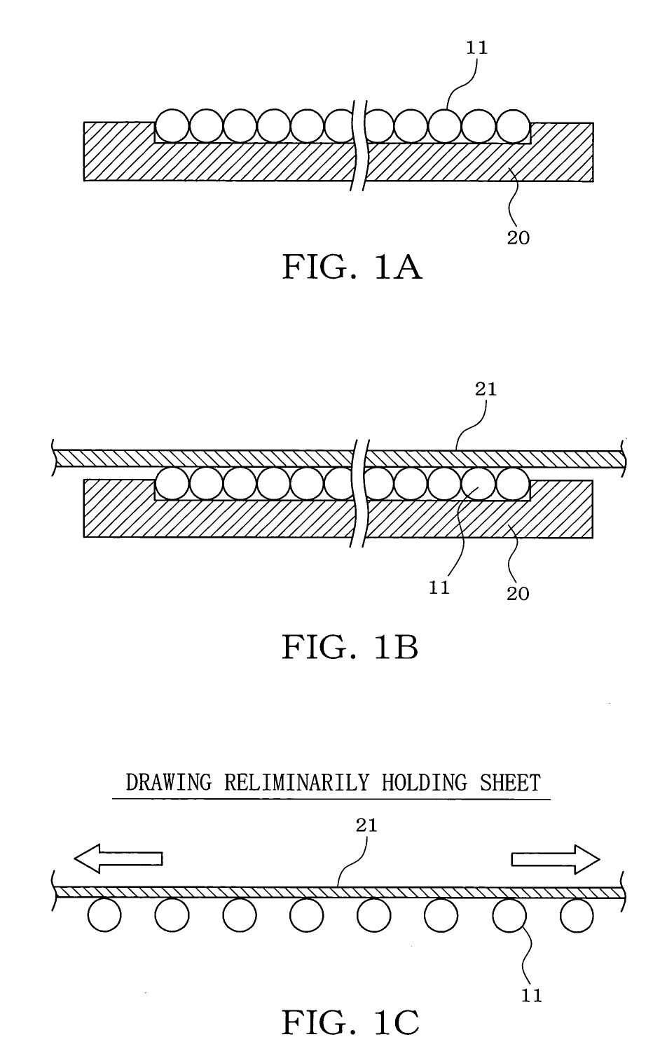

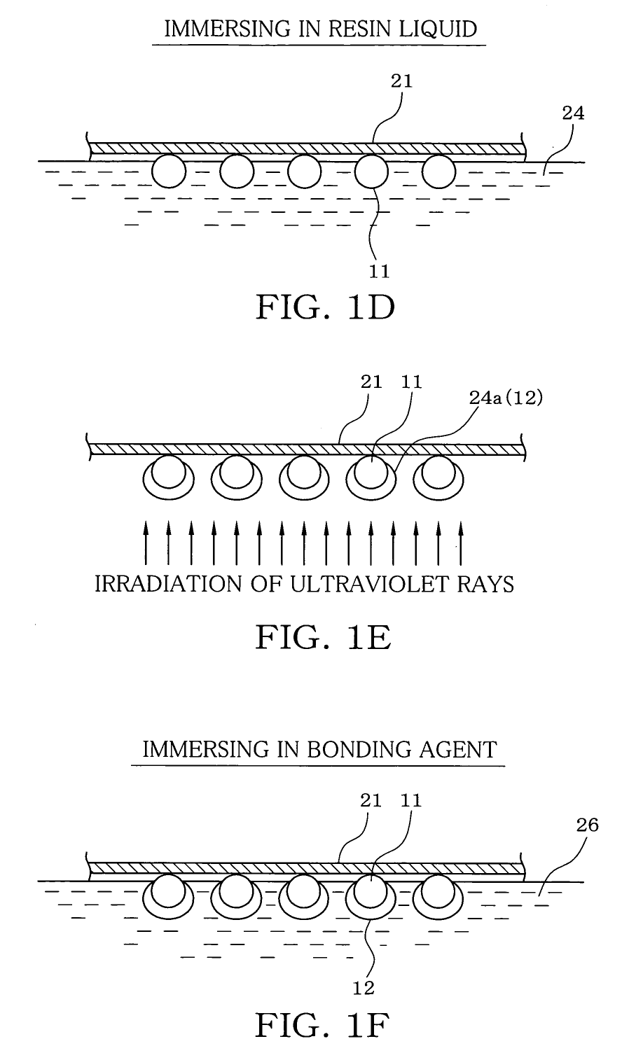

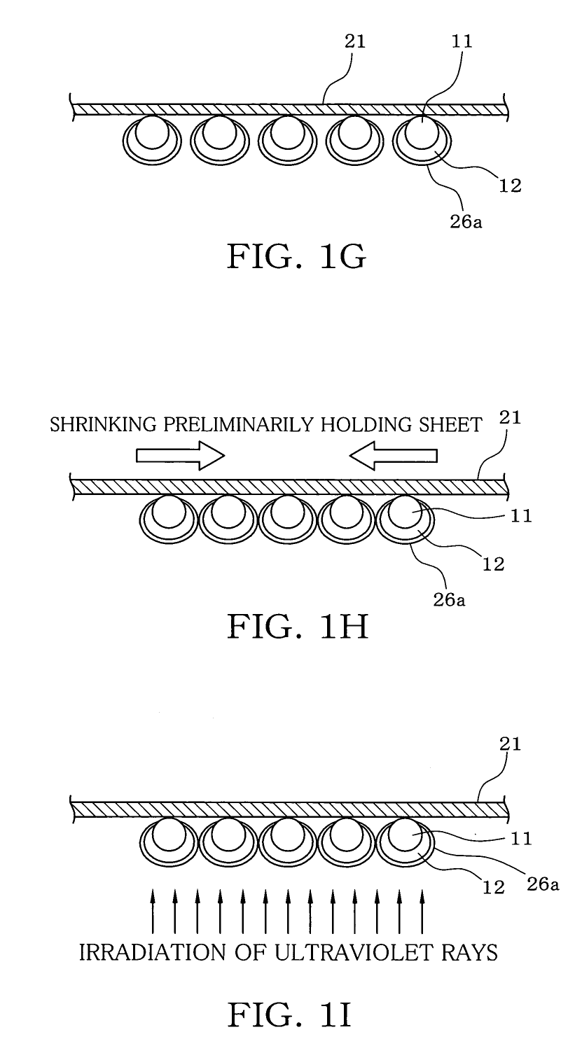

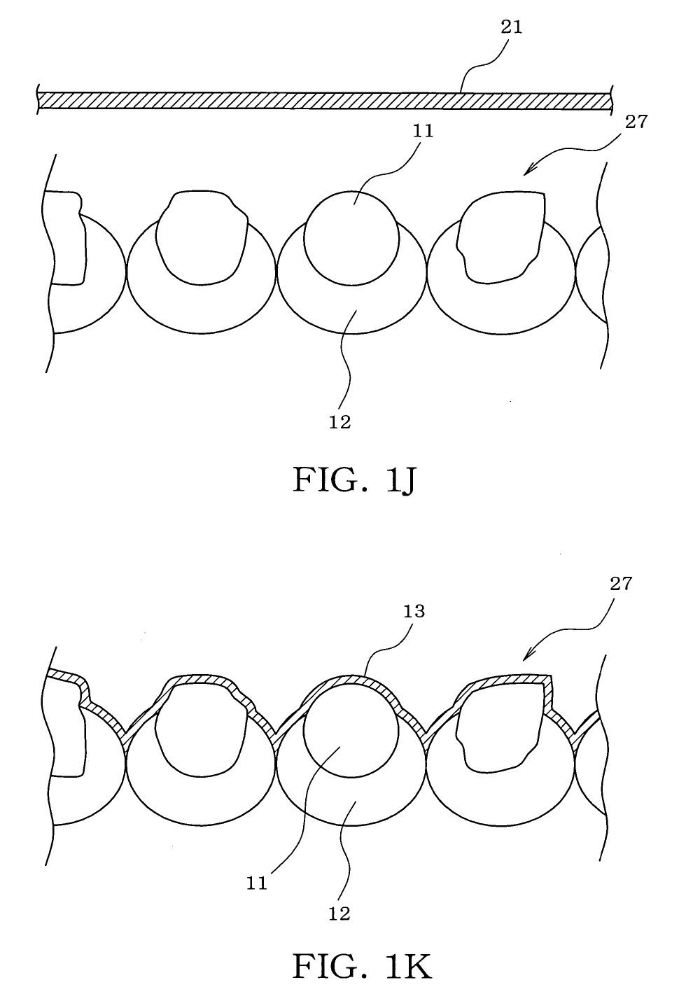

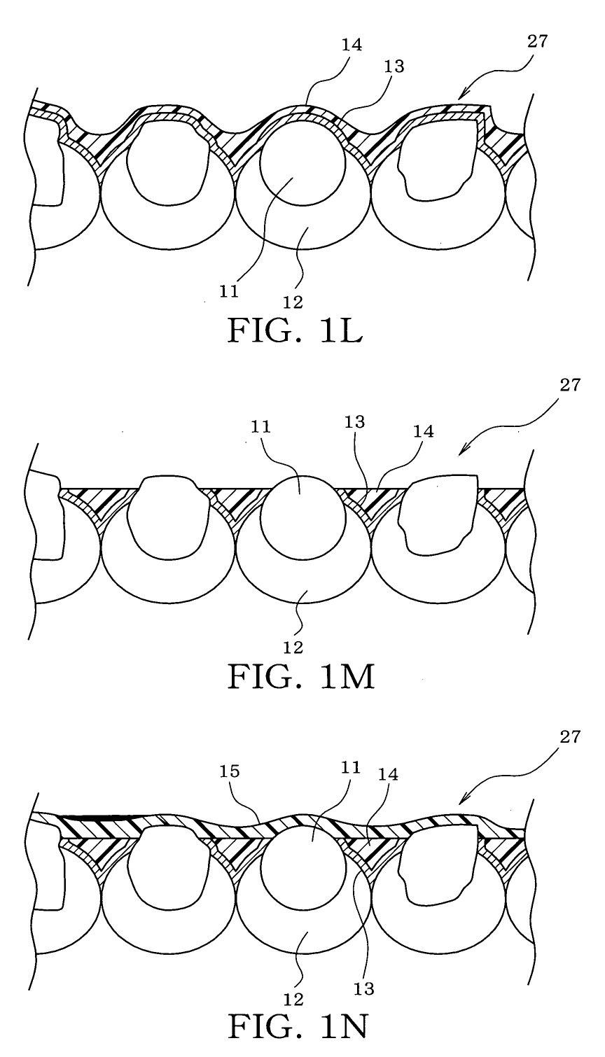

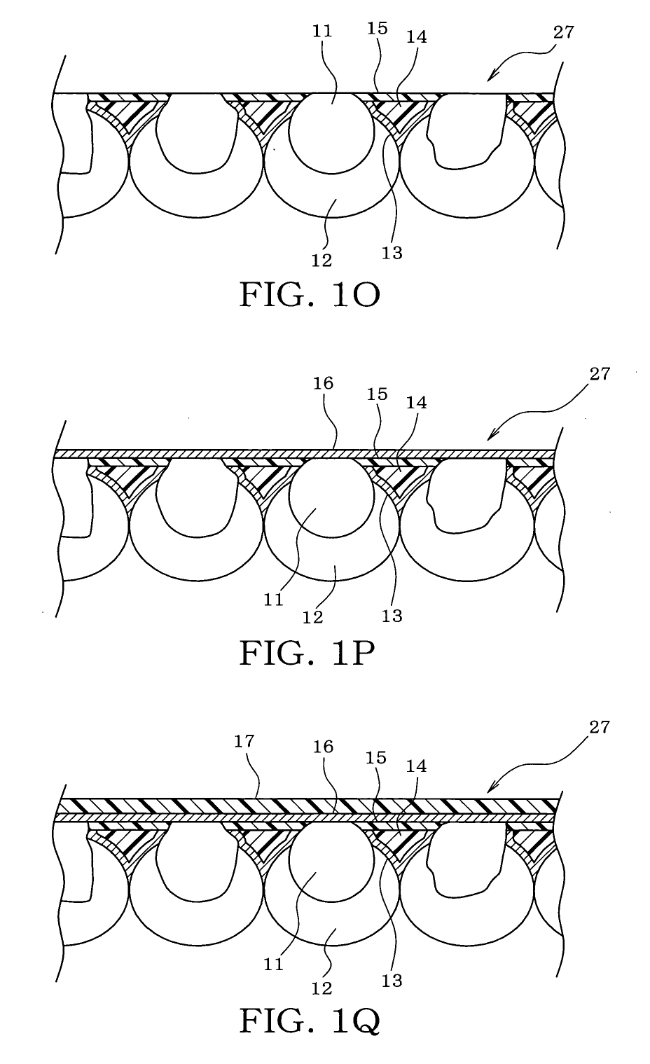

FIG. 1P illustrates a process of forming positive electrodes over the entire backside of the photovoltaic panel so that the positive electrodes are adhered to the exposed faces of the p-type semiconductor devices;

FIG. 1Q illustrates a process of forming a protecting insulating layer over the entire positive electrode face of the backside of the photovoltaic panel;

FIG. 2A illustrates a state of an apparatus for preliminarily drawing the preliminarily holding sheet uniformly in the direction of extension of the sheet before the sheet is drawn out;

FIG. 2B illustrates a state of the apparatus for preliminarily drawing the preliminarily holding sheet uniformly in the direction of extension of the sheet after the sheet has been drawn out;

FIG. 2C illustrates a process of immersing, in the resin liquid, the photovoltaic devices on the lower side of the preliminarily holding sheet; and

FIG. 3 illustrates a data of measured relationship between projected area ratios of the lens and photovoltaic device and output current I_{sc}.

### DETAILED DESCRIPTION OF THE INVENTION

One embodiment of the invention will be described with reference to the drawings. First, the structure of the photovoltaic panel 27 manufactured by the method in accordance with the embodiment of the invention with reference to FIG. 1Q.

The photovoltaic panel 27 comprises a number of spherical or granular photovoltaic devices 11 arranged side by side and integrated. Each photovoltaic device 11 includes a thin n-type semiconductor layer in the outer periphery thereof and a p-type semiconductor layer in the inner peripheral side. A method of manufacturing the photovoltaic device 11 should not be limited to a particular one and the free fall method described in international publication No. WO99/10935, the plasma-assisted CVD method described in JP-A-2002-60943 or another method may be employed. At a light-receiving side of each photovoltaic device 11, a spherical convex lens 12 is made from a light-transmissible ultraviolet curing resin. Each photovoltaic device 11 is bonded to the adjacent one by a light-transmissible bonding agent so that the photovoltaic devices 11 are integrated. It is preferable that the bonding agent is the same ultraviolet curing resin as formed into each lens 12 but has a lower viscosity than that of each lens 12. However, the material for the bonding agent should not be limited to the aforementioned.

A negative electrode 13 causing an outer peripheral n-type semiconductor layer of each photovoltaic device 11 to conduct is formed on the backside of the photovoltaic panel (upper side in FIG. 1Q) so as to cover the backside of the lens 12. The negative electrode 13 is completely covered with two insulating resin layers 14 and 15. The lower insulating resin layer 14 serves as a protecting layer (mask) in etching as will be described later, whereas the upper insulating resin layer 15 serves as an insulating layer insulating the negative electrode 13 and positive electrode 16.

The n-type semiconductor layer is partially removed by abrasion etc. such that a portion at which the p-type semiconductor layer is exposed is formed in a rear end of each photovoltaic device 11. A positive electrode 16 is formed so as to cause the p-type semiconductor layer to conduct. The positive electrode 16 is completely covered with a protective insulating layer 17 made from an insulating resin etc., thereby being protected and insulated.

A method of manufacturing the photovoltaic panel 27 constructed above will be described. As described above, the method of manufacturing the spherical or granular photovoltaic device 11 is not limited to a particular method and any method may be used to make the spherical or granular photovoltaic device 11. One manufacturer may continuously carry out all the processes from manufacture of the photovoltaic devices 11 to manufacture of the photovoltaic panel, or one manufacturer may purchase photovoltaic devices 11 manufactured by another manufacturer and manufacture the photovoltaic panels. The following describes sequential processes for manufacturing the photovoltaic panels 27 using the spherical or granular photovoltaic devices 11 manufactured by any method.

[1] Preliminarily Holding Process:

Firstly, as shown in FIG. 1A, a large number of spherical or granular photovoltaic devices 11 are accommodated in a shallow casing 20 to be arranged side by side in a crowded state so as not to be laid one upon another. Subsequently, as shown in FIG. 1B, a preliminarily holding sheet 21 with an underside coated with an adhesive agent is pressed against the photovoltaic devices 11 in the casing 20 from above thereby to be adhered (preliminarily held) while the photovoltaic devices 11 are crowded without any space between the photovoltaic devices 11. In this case, a sheet is used which is made from an elastic material, such as rubber, contractible and expandable in a direction of extension of the sheet or a direction perpendicular to the thickness of the sheet, so that the photovoltaic devices 11 are caused to adhere to the preliminarily holding sheet 21 while the sheet is in a slightly expanded state so as not to be loosened.

Subsequently, as shown in FIG. 1C, the preliminarily holding sheet 21 is drawn up in the direction of extension of the sheet in a range of 360°, whereupon a uniform space is spread between the photovoltaic devices 11. In this case, the space between the photovoltaic devices 11 adjacent to each other is increase to such a degree that the lens 12 formed in the subsequent process are prevented from being brought into contact with each other.

An example of apparatus for drawing the sheet 21 will be described with reference to FIGS. 2A and 2B. The preliminarily holding sheet 21 is attached to an annular holder 22 in a slightly stretched state so as not to be loosened. An annular pusher 23 is coaxially provided in the inner peripheral side so as be moved up and down. The annular pusher 23 is pressed against the upper side of the preliminarily holding sheet 21 while the annular holder 22 is fixed in a position. Only the annular pusher 23 is descended by an air cylinder or the like so that the preliminarily holding sheet 21 is drawn along the underside of the annular pusher 23 uniformly in the direction of extension of the sheet.

In this case, an amount of drawing of the preliminarily holding sheet 21 is rendered large as an amount of descent of the annular pusher 23 (an amount of pressing applied to the preliminarily holding sheet 21) becomes larger, whereupon a space between the photovoltaic devices 11 on the underside of the preliminarily holding sheet 21 is increased. Accordingly, a descending stroke of the annular pusher 23 is adjusted when the space between the photovoltaic devices 11 is adjusted. However, when the descending stroke of the annular pusher 23 cannot be adjusted, the height of the annular holder 22 is adjusted so that a vertical space between the pusher 23 and sheet 21 before start of descent of the pusher (or a distance between the sheet 21 and the pusher 23 which is abutted against the sheet 21 after start of descent), whereby an amount of pressing applied to the sheet 21 is adjusted.

Alternatively, only the annular holder 22 may be raised while the annular pusher 23 is fixed in position, so that the preliminarily holding sheet 21 is drawn uniformly in the direction perpendicular to the direction of its thickness.

[2] Liquid Resin Applying Process:

The photovoltaic devices 11 on the underside of the preliminarily holding sheet 21 are immersed in the liquid resin 24 simultaneously while the sheet 21 is drawn uniformly in the direction of extension of the sheet by the above-described method such that a uniform space is defined between the photovoltaic devices 11, as shown in FIG. 1D. A light-transmissible ultraviolet curing resin is preferably used as the liquid resin 24. In this case, the preliminarily holding sheet 21 may be descended so that the photovoltaic devices 11 on the underside thereof are immersed in the liquid resin 24. However, as shown in FIG. 2C, a resin liquid reservoir 25 may be raised while the preliminarily holding sheet 21 is fixed in position, so that the photovoltaic devices 11 are immersed in the liquid resin 24, instead.

In the liquid resin attaching process, only the photovoltaic devices 11 needs to be immersed in the liquid resin 24 so that the liquid resin 24 is prevented from adhering to the preliminarily holding sheet 21. The reason for this is that if applied to the preliminarily holding sheet 21, the liquid resin 24 inadvertently serves as a bonding agent boding the sheet 21 to the photovoltaic panel 27, whereupon it becomes difficult to remove the sheet 21 or the adherent resin becomes an obstacle preventing shrinkage of the sheet 21. Thus, there is a possibility that the lens 11 of the respective photovoltaic devices 11 may not be bonded together.

However, since a desirable thicker lens 12 can be made as an amount of liquid resin 24 adherent to each photovoltaic device 11 becomes large. Accordingly, it is desirable to increase an amount of liquid resin 24 adherent to each photovoltaic device 11 as much as possible. For this purpose, it is preferable to immerse each photovoltaic device 11 in the liquid resin 24 as deep as possible without the liquid resin 24 adherent to the preliminarily holding sheet 21. An amount of liquid resin 24 adherent to each photovoltaic device 11 can also be adjusted by the viscosity of the liquid resin 24 or the composition of resin.

After having been immersed in the liquid resin 24, the photovoltaic devices 11 on the underside of the preliminarily holding sheet 21 are ascended out of the liquid resin 24. As a result, as shown in FIG. 1E, the liquid resin 24a adherent to each photovoltaic device 11 is formed into the shape of a spherical convex lens by the surface tension thereof.

[3] Resin Hardening Process:

After completion of the liquid resin attaching process, the manufacturing sequence advances to a resin hardening process so that ultraviolet rays are irradiated onto the liquid resin 24a adherent to the surface of each photovoltaic device 11 on the underside of the preliminarily holding sheet 21 thereby to harden the liquid resin 24a, so that the resin lends 12 are formed on the surfaces of the photovoltaic devices 11 respectively.

The manufacturing sequence advances to a subsequent bonding agent applying process when each of the liquid resin applying process and the resin hardening process are carried out once such that the lends 12 with target thickness is obtained. On the other hand, when the target lens 12 cannot be obtained in this case, the liquid resin applying process and the resin hardening process are carried out alternately at a predetermined number of times so that the lens 12 formed on the surface of each photovoltaic device 11 reaches the target thickness. Thus, the number of times of immersing the photovoltaic devices 11 in the liquid resin 24 and hardening the resin is adjusted, whereby the thickness of each lens 12 can be adjusted. A thick lends 12 can be manufactured.

[4] Bonding Agent Applying Process:

Each of the liquid resin applying process and the resin hardening process is carried out at a suitable number of times so that the lens 12 having a target thickness are obtained. Subsequently, the manufacturing sequence advances to a bonding agent applying process. As shown in FIG. 1F, the lens 12 of the photovoltaic devices 11 on the underside of the preliminarily holding sheet 21 are simultaneously immersed in a liquid bonding agent 26 and then ascended so that the bonding agent 26a is caused to adhere to the surfaces of the lens 12 as shown in FIG. 1G. In the bonding agent applying process, too, only the lens 12 of the photovoltaic devices 11 need to be immersed in the liquid bonding agent 26 so that the liquid bonding agent 26a is prevented from adhering to the preliminarily holding sheet 21.

In this case, the bonding agent 26 comprises the same light-transmissible ultraviolet curing resin as of each lens 12, which resin has a lower viscosity. Consequently, the bonding agent 26a can collectively be caused to adhere to the surfaces of the lens 12 in the same method as forming the lens 12 (immersion). Thus, the bonding agent applying work is exceedingly easy. Moreover, optical characteristics of the post-hardened bonding agent 26a can be caused to correspond with those of the lens 12 completely, and the bonding agent 26a can be integrated completely into a part of the lens 12. Consequently, the bonding agent 26a can prevent the optical characteristics of the lens 12 from being worsened or reduced. Alternatively, the bonding agent 26a may be applied to the surface of each lens 12 and thus, the bonding agent 26a may be applied to the surface of each lens 12 by a method other than the immersion, for example painting.

[5] Bonding Process:

After completion of the bonding agent applying process, the manufacturing sequence advances to a bonding process. As shown in FIG. 1H, in consideration of the thickness of each lens 12, the preliminarily holding sheet 21 is shrunk in the direction of extension of the sheet such that the bonding agent 26a of the lens 12 of each photovoltaic device 11 is brought into contact with the bonding agent 26a of the lens 12 of the adjacent photovoltaic device 11. Shrinking the preliminarily holding sheet 21 is an operation in the opposite direction to drawing the sheet as described in the preliminarily holding process.

While the bonding agent 26a of each photovoltaic device 11 is in contact with the bonding agent 26a of the adjacent photovoltaic device 11, ultraviolet rays are irradiated onto the bonding agent 26a so that the bonding agent 26a is hardened, as shown in FIG. 1I. As a result, the lens 12 of each photovoltaic device 11 is bonded to the lens 12 of the adjacent photovoltaic device 11 by the bonding agent 26a, whereby the photovoltaic panel 27 is formed. When the preliminarily holding sheet 21 is loose during hardening the bonding agent 26a such that an array of the photovoltaic devices 11 is curved, a curved photovoltaic panel 27 would be formed. Accordingly, the preliminarily holding sheet 21 needs to be held in a stretched straightforward state.

[6] Preliminarily Holding Sheet Removing Process:

After completion of the bonding process, the manufacturing sequence advances to a preliminarily holding sheet removing process. As shown in FIG. 1J, the preliminarily holding sheet 21 is removed from the backside of the photovoltaic panel 27. In this case, if the liquid resin 24 or the bonding agent 26 isn't adherent to the preliminarily holding sheet 21, it can easily be removed from the backside of the photovoltaic panel 27.

[7] Negative Electrode Forming Process:

After completion of the preliminarily holding sheet removing process, the manufacturing sequence advances to a negative electrode forming process. As shown in FIG. 1K, a negative electrode 13 is formed on the entire backside of photovoltaic panel 27 using a conductor forming technique such as vapor deposition, metal plating, coating, chemical vapor deposition (CVD) or sputtering. It is preferable that a conductor having a small electric resistance value and tending to reflect light (to serve as a reflecting surface for incident light), such as Ag or an Ag-containing conductor. The negative electrode 13 causes an outer peripheral n-type semiconductor layer of each photovoltaic device 11 to conduct and covers the backside of the lens 12 to serve as a reflecting surface for incident light.

[8] Protecting Layer (Lower Insulating Resin Layer) Forming Process:

After completion of the negative electrode forming process, the manufacturing sequence advances to a protecting layer forming process. As shown in FIG. 1L, an insulating resin such as an epoxy resin is applied to the entire negative electrode 13 on the backside of the photovoltaic panel 27 and hardened thereby to be formed into a protecting layer 14 (lower insulating resin layer). Thus, the entire negative electrode 13 is covered by the protecting layer 14. A resin formed into the protecting layer 14 may be a thermosetting resin, ultraviolet curing resin, anaerobic curing resin or the like but needs to have suitable insulation and resistance to etching (to be used as a mask in the etching).

[9] Sandblasting Process:

After completion of the protecting layer forming process, the manufacturing sequence advances to a sandblasting process. As shown in FIG. 1M, the protecting layer 14 and the negative electrode 13 on the rear end of each photovoltaic device 11 are partially removed by sandblasting, whereupon the negative type semiconductor layer on the rear end of each photovoltaic device 11 is exposed. Abrasion, laser processing, electrical discharge machining or the like may be employed to remove parts of the protecting layer 14 and the negative electrode 13, instead of sandblasting.

[10] Etching Process:

After completion of the sandblasting process, the manufacturing sequence advances to an etching process to remove the n-type semiconductor on the rear end of the photovoltaic device 11 exposed from the protecting layer 14 using the protecting layer 14 as a mask (etching resist) by chemical etching. As a result, the inside p-type semiconductor layer is exposed. Dry etching may be employed instead of chemical etching.

[11] Insulating Layer (Upper Insulating Resin Layer) Forming Process:

After completion of the etching process, the manufacturing sequence advances to an insulating layer (upper insulating resin layer) forming process. As shown in FIG. 1N, an insulating resin such as epoxy resin is applied to the entire backside of the photovoltaic panel 27 and hardened thereby to be formed into an insulating layer 15 (upper insulating resin layer). As a result, the negative electrode 13 which has partially been exposed in the sandblasting process is completely covered with the insulating layer 15. The resin formed into the insulating layer 15 may be the same as or different from the lower protecting layer 14 and may be a thermosetting resin, ultraviolet curing resin, anaerobic curing resin or the like.

[12] Polishing Process:

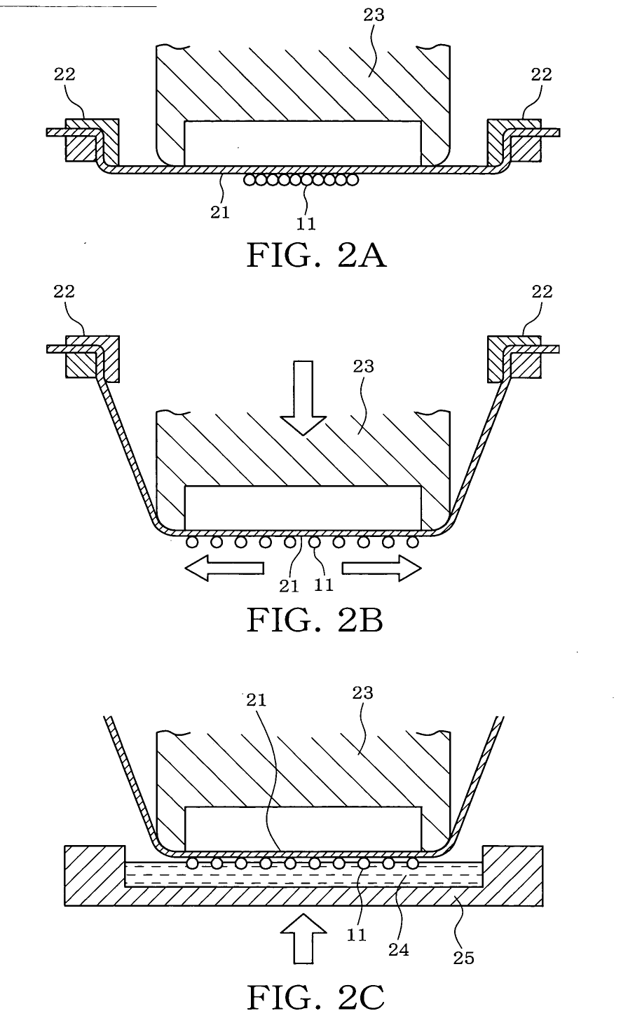

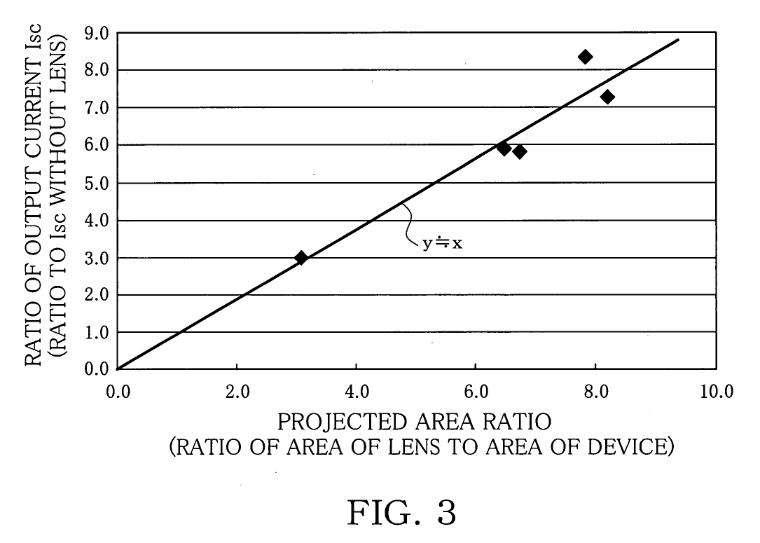

After completion of the insulating layer forming process, the manufacturing sequence advances to a polishing process. As shown in FIG. 10, the insulating layer 15 of the backside of the photovoltaic panel 27 is polished by a polishing machine and flattened. Further, the p-type semiconductor layer of the rear end of each photovoltaic device 11 is exposed from the insulating layer 15, and an exposed face of the p-type semiconductor layer is flattened. Alternatively, the insulating layer 15 may be polished by the sandblast.

[13] Positive Electrode Forming Process:

After completion of the polishing process, the manufacturing sequence advances to a positive electrode forming process. As shown in FIG. 1P, a positive electrode 16 is formed on the entire backside of the photovoltaic panel 27 so as to adhere closely to the exposed face of the p-type semiconductor layer of each photovoltaic device 11. A conductor composing the positive electrode 16 may be the same as or different from the conductor composing the negative electrode 13. A method of forming the positive electrode 16 may be the same as or different from the method of forming the negative electrode 13. For example, a conductor such as Al may be rubbed against the entire backside of the photovoltaic panel 27 so that a frictional force and frictional heat cause the conductor to adhere to the exposed face of the p-type semiconductor layer and insulating layer 15, so that the positive electrode 16 is formed.

[14] Laser Sintering Process:

After completion of the positive electrode forming process, the manufacturing sequence advances to a laser sintering process, in which process laser beams are spot-irradiated onto a central junction of the positive electrode 16 and the p-type semiconductor layer of the rear end of each photovoltaic device 11. As a result, the central junction is spot-heated so that the positive electrode 16 is heat-treated so as to be formed into an ohmic contact.

[15] Protective Insulating Layer Forming Process:

After completion of the laser sintering process, the manufacturing sequence advances to a protective insulating layer forming process. As shown in FIG. 1Q, an insulating resin is applied to the entire positive electrode 16 of the backside of the photovoltaic panel 27 and hardened to be formed into a protective insulating layer 17, which covers the entire positive electrode 16. The resin formed into the protective insulating layer 17 may be a thermosetting resin, ultraviolet curing resin, anaerobic curing resin or the like. Manufacture of the photovoltaic panel 27 is completed when the foregoing processes 1 to 15 have been carried out thoroughly.

According to the foregoing embodiment, a number of spherical or granular photovoltaic devices 11 are preliminarily held on the preliminarily holding sheet 21 and immersed in the resin liquid 24 and ascended. The resin liquid 24a adherent to the surface of each photovoltaic device 11 is hardened so that the resin lens 12 is formed on the surface of each photovoltaic device 11. Accordingly, the spherical convex lens 12 can be formed on the surface of each photovoltaic device 11 by the surface tension of the resin liquid 24a. Consequently, the suitable spherical convex lens 12 can collectively be formed on the surfaces of the photovoltaic devices 11 by the surface tension of the resin liquid 24a respectively even when the photovoltaic devices 11 have variations in the size (diameter) and shape (sphericity). Further, each photovoltaic device 11 can be positioned on the center of the lens 12. Moreover, no expensive forming machine, such as forming dies for injection molding, forming the lens 12 is required. Thus, optimization of the shape of lens 12 and low costs can be achieved simultaneously. Further, the preliminarily holding sheet 21 is shrunk in the direction of extension of the sheet after formation of the lens 12, so that the lens 12 of each photovoltaic device 11 is bonded to the lens 2 of the adjacent one by the bonding agent 26. Consequently, the photovoltaic devices 11 can be integrated by an easy and cost-effective method without using expensive forming equipment. Thus, a photovoltaic panel 27 provided with lens 12 and having a high generating efficiency can be manufactured.

Further, since the electrode 13, 16 of each photovoltaic device 11 is formed on the backside of the photovoltaic panel 27, light incident on the photovoltaic devices 11 can be prevented from being intercepted by the electrode 13, 16 and accordingly, the entire surface of each lens 12 can effectively serve as a light-receiving face.

Further, since the negative electrode 13 is formed so as to cover the backside of each lens 12, it can serve as a reflecting surface of incident light and accordingly, the generating efficiency (an amount of received light of each photovoltaic device 11) can further be increased by the light reflection of the negative electrode 13.

In order to evaluate the condensing effect of each lens 12 of the photovoltaic panel 27 manufactured by the method of the embodiment, the inventor made samples of some photovoltaic panels 27 having respective lens 12 with different sizes and measured output current I_{sc} in the case where the same intensity of sunlight was irradiated onto each photovoltaic panel 27. FIG. 3 shows a graph of measurement data. In FIG. 3, an axis of abscissas indicates a projected area ratio of the lens 12 to photovoltaic device 11, whereas an axis of ordinates indicates a ratio (I_{sc}/Iₒ) of output current I_{sc} of the photovoltaic panel 27 with lends 12 to output current Iₒ of the photovoltaic panel without lens 12. The lens 12 has a larger condensing effect as the aforementioned output current ratio is increased.

In the test, the output current ratios were measured with respect to five samples having respective projected area ratios of 3.0, 6.0 and 8.0. As a result, values approximate to 3.0, 6.0 and 8.0 respectively were obtained. The results of the test show that the output current I_{sc} can be increased substantially in proportion to the increase in the projected area ratio of the lens 12 to photovoltaic device 11. Consequently, it can be confirmed that a photovoltaic panel 27 having a high generating efficiency can be manufactured at lower costs using a smaller number of photovoltaic devices 11 than in the conventional arrangement.

Further, in the foregoing embodiment, a sheet made from an elastic material expandable and contractible in the direction of extension of the sheet serves as the preliminarily holding sheet 21. As shown in FIGS. 1B and 2A, a number of photovoltaic devices 11 are caused to adhere closely to one side of the preliminarily holding sheet 21 and thereafter, the sheet 21 is drawn uniformly in the direction of extension of the sheet. As a result, since each photovoltaic device 11 is uniformly spaced from the adjacent one, the photovoltaic devices 11 need not be arranged while being spaced from each other before photovoltaic devices 11 are caused to adhere to one side of the preliminarily holding sheet 21. Thus, it is advantageous that the photovoltaic device 11 can be caused to adhere to one side of the preliminarily holding sheet 21 easily. Moreover, it is advantageous that a uniform space can be defined between the photovoltaic devices 11 by an easy method of uniformly drawing the sheet in the direction of extension of the sheet.

Alternatively, in the present invention, the preliminarily holding sheet 21 may be drawn uniformly in the direction of extension of the sheet before the photovoltaic devices 11 are caused to adhere to one side of the preliminarily holding sheet 21. In this state, the photovoltaic devices 11 may be caused to adhere to one side of the preliminarily holding sheet 21 while being spaced uniformly from one another.

Further, the preliminarily holding sheet may be made from a heat-shrinkable material, instead of the elastic material such rubber. In this case, the photovoltaic devices 11 may be caused to adhere to one side of the preliminarily holding sheet without being drawn in the direction of extension of the sheet while being spaced uniformly from one another. Upon completion of the bonding agent applying process, the preliminarily holding sheet may be heated thereby to be shrunk in the direction of extension of the sheet.

Further, since the light-transmissible ultraviolet curing resin is used as the resin formed into the lens 12 and the bonding agent 26 in the embodiment, the resin and the bonding agent 26 can be hardened by ultraviolet radiation in a short period of time (several to several tens seconds) and accordingly, the yield can be improved. Moreover, in the embodiment, the same type of resin (with only different viscosity) as formed into the lens 12 is used as the bonding agent 26. The bonding agent 26a is caused to adhere uniformly to the surface of the lens 12 of each photovoltaic device 11 by the immersion method. Accordingly, optical characteristics of each lens 12 can be prevented from being reduced by the bonding agent 26a.

Alternatively, a bonding agent having composition different from the resin formed into each lens 12 may be used in the present invention. Further, a light-transmissible thermosetting resin, a light-transmissible anaerobic curing resin or the like may be used as the material for either one or both of the resin formed into each lens 12 and the bonding agent 26, instead of the light-transmissible ultraviolet curing resin.

1. A method of forming a condensing lens on a surface of a spherical or granular photovoltaic device, comprising:
immersing the photovoltaic device in a liquid resin and lifting the photovoltaic device, thereby applying the liquid resin to the surface of the photovoltaic device; and
hardening the liquid resin applied to the surface of the photovoltaic device, thereby forming a resin lens on the surface of the photovoltaic device.

2. The method according to claim 1, wherein the liquid resin applying process and the liquid resin hardening process are repeated alternately at a predetermined number of times so that the lens formed on the surface of the photovoltaic device has an increased thickness.

3. The method according to claim 1, wherein the resin formed into the lens comprises a light-transmissible ultraviolet curing resin.

4. A method of manufacturing a photovoltaic panel having an array of a number of spherical or granular photovoltaic devices, comprising:
preliminarily holding the photovoltaic devices on one side of a preliminarily holding sheet with a space between each device and an adjacent one;
immersing the photovoltaic devices held on the side of the preliminarily holding sheet in a liquid resin and lifting the photovoltaic devices, thereby applying the liquid resin to the surfaces of the photovoltaic devices;
hardening the liquid resin applied to the surfaces of the photovoltaic devices, thereby forming resin lens on the surfaces of the photovoltaic devices respectively;
applying a bonding agent to surfaces of the lens; and
shrinking the preliminarily holding sheet in a direction of extension of the sheet so that the lens of each photovoltaic device is bonded to the lens of the adjacent one, thereby forming the photovoltaic panel.

5. The method according to claim 4, wherein the liquid resin applying process and the liquid resin hardening process are repeated alternately at a predetermined number of times so that the lens formed on the surface of each photovoltaic device has an increased thickness.

6. The method according to claim 4, wherein after the preliminarily holding sheet has been removed from the photovoltaic panel, an electrode of each photovoltaic device is formed on a side of the photovoltaic panel from which the preliminarily holding sheet has been removed.

7. The method according to claim 6, wherein the electrode is formed so as to cover a backside of each lens.

8. The method according to claim 4, wherein in the preliminarily holding process, a sheet made from an elastic material expandable and contractible in the direction of extension of the sheet serves as the preliminarily holding sheet, and the photovoltaic devices are caused to adhere to one side of the preliminarily holding sheet in a closely massed state and thereafter, the preliminarily holding sheet is drawn out uniformly in the direction of extension of the sheet so that a uniform space is defined between each photovoltaic device and the adjacent one.

9. The method according to claim 4, wherein only the photovoltaic devices are immersed in the liquid resin so that the liquid resin is prevented from adhering to the preliminarily holding sheet in the immersing process.

10. The method according to claim 4, wherein each of the resin formed into the lens and said bonding agent comprises a light-transmissible ultraviolet curing resin.

11. The method according to claim 4, wherein said bonding agent comprises a resin which is the same as forming each lens but has a lower viscosity than the resin forming each lens.

12. The method according to claim 4, wherein in the bonding agent applying process, the lens of the photovoltaic devices preliminarily held on the preliminarily holding sheet are immersed in a liquid of said bonding agent so that the bonding agent adheres to the surface of the lens of each photovoltaic device.
